(19) United States
(12) Patent Application Publication
(10) Pub. No.: US 2015/0360165 A1
(43) Pub. Date: Dec. 17, 2015

(54) SEPARATION OF BIOLOGICALLY GENERATED GAS STREAMS

(71) Applicant: LINDE AKTIENGESELLSCHAFT, Munich (DE)

(72) Inventors: Christopher CARSON, Bussum (NL); Satish TAMHANKAR, Scotch Plains, NJ (US); Rustam SETHNA, Clinton, NJ (US)

(21) Appl. No.: 14/763,189

(22) PCT Filed: Jan. 30, 2014
(86) PCT No.: PCT/EP2014/051774

§ 371 Date: Jul. 24, 2015

(30) Foreign Application Priority Data
Jan. 31, 2013 (GB) 1301742.1

(51) Int. Cl. B01D 53/04; B01D 53/047; H01M 8/14; B01D 53/22; H01M 8/06

(52) U.S. Cl. CPC B01D 53/0407; B01D 53/229; H01M 8/0662; H01M 8/145; B01D 53/047; B01D 53/0462; B01D 53/0476; H01M 8/0668; H01M 8/0687; B01D 2257/304; B01D 2257/708; B01D 2257/80; B01D 2257/504; B01D 2253/102; B01D 2253/108; B01D 2053/221

(57) ABSTRACT

A method and apparatus for separating a compressed, biologically generated, feed gas stream comprising methane, carbon dioxide, water vapour and impurities including volatile non-methane organic compounds. The method comprises purifying the compressed, biologically generated, feed stream by adsorption to remove the volatile non-methane organic compounds and the water vapour and to form a purified feed stream. The purified feed stream is separated by membranes to produce a first product gas stream enriched in methane and an intermediate gas stream enriched in carbon dioxide. Part of the first product gas stream is withdrawn and mixed with at least part of the intermediate gas stream to form a second product gas stream comprising methane and carbon dioxide.

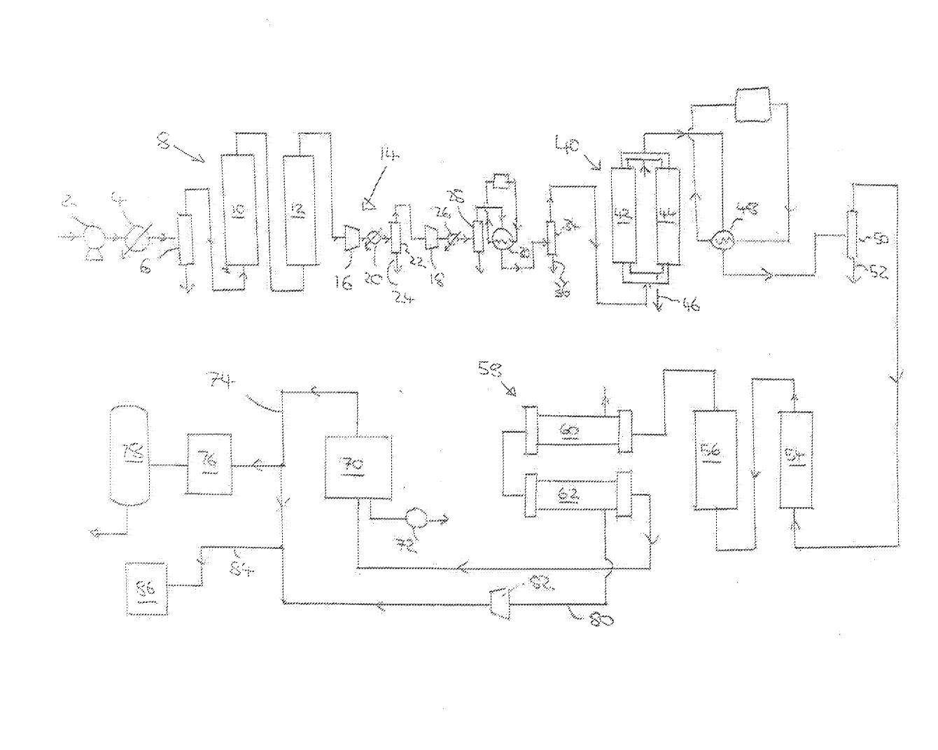

This invention relates to a method of and apparatus for separating a compressed, biologically generated, feed gas stream comprising methane, carbon dioxide, water vapour and impurities including volatile non-methane organic compounds.

Methane is usually generated when organic matter decomposes. There is increasing industrial interest in recovering methane from biological sources. For example, it is known to recover methane from the anaerobic digestion of municipal or industrial organic waste or from the degradation of a biomass in, for example, a landfill site.

One drawback to the production of methane by such biological routes is that the resulting gas contains a wide range of impurities. Typically, the gas contains a significant proportion of carbon dioxide. If the source of the biologically generated gas is a landfill site, there will also be a significant quantity of nitrogen present. In addition, there may be contamination with gases such as hydrogen sulphide and with particulate materials. Furthermore, the biologically generated gas tends to contain a wide range of volatile organic contaminants, collectively known as “NMOCs” (non-methane organic compounds).

A wide range of different purification and separation processes have been proposed for the recovery of methane from such gas mixtures. In view of the complexity of the mixtures, these processes typically involve several different steps in some of which methane product is lost.

U.S. Pat. No. 7,025,803 discloses a process for recovering methane from landfill gas. The landfill gas is compressed and the resulting compressed landfill gas passes through coalescing filters to remove liquid impurities. Downstream of the coalescing filters the landfill gas is subjected to purification by pressure swing adsorption. The pressure swing adsorption employs an adsorbent that is capable of selectively or preferentially adsorbing water vapour, volatile organic compounds, hydrogen sulphide and siloxane from the stream of compressed landfill gas. The thus purified landfill gas stream flows through a polishing bed of activated carbon adsorbent to remove residual traces of impurities, particularly the volatile organic compounds. Downstream of the polishing step, the purified landfill gas is subjected to two steps of membrane separation so as to effect a separation as between methane and carbon dioxide. The carbon dioxide permeates through the membranes more rapidly than the methane, thus enabling the separation to be carried out. The membrane separation step produces a relatively pure product methane stream and two permeate streams which are enriched in carbon dioxide, but which also contain methane.

According to U.S. Pat. No. 7,025,803 the permeate gas from the upstream membrane separation is employed to regenerate the beds of the PSA unit. Downstream of this unit the permeate gas is flared. The permeate gas from the downstream membrane unit is recycled to the compressor. In this way loss of methane is kept down. However, the recycle does have the effect of enhancing the flow through the separation units, therefore resulting in an increased rate of methane loss in the permeate gas from the upstream membrane separation. In addition, additional power is consumed in the compressor. Furthermore, further downstream purification of the methane product is required if it is to be liquefied.

According to the present invention there is provided a method of separating a compressed, biologically generated, feed gas stream comprising methane, carbon dioxide, water vapour and impurities including volatile non-methane organic compounds, comprising:
purifying the compressed, biologically generated, feed stream by adsorption to remove the volatile non-methane organic compounds and the water vapour and to form a purified feed stream;
separating the purified feed stream by membranes to produce a first product gas stream enriched in methane and an intermediate gas stream enriched in carbon dioxide; and
withdrawing a part of the first product gas stream therefrom and mixing said part with at least part of the intermediate gas stream to form a second product gas steam comprising methane and carbon dioxide.

The invention also provides apparatus for separating a compressed, biologically generated, feed gas stream comprising methane, carbon dioxide, water vapour and impurities including volatile non-methane organic compounds, comprising:
at least one adsorber for removing the volatile non-methane organic compounds and the water vapour and for forming a purified feed stream;
at least one membrane separator for producing from the purified feed stream a first product gas stream enriched in methane and an intermediate gas stream enriched in carbon dioxide;
a first pipeline for conducting part of the product gas stream to a first outlet from the apparatus;
a second pipeline for conducting the intermediate gas stream from the said membrane separator;
a third pipeline for conducting a second product gas stream from the apparatus;
wherein the third pipeline communicates with both the first pipeline and the second pipeline so as to enable a mixture of part of the first product gas stream and at least part of the intermediate gas stream to be formed as the second product gas stream.

The method and apparatus according to the invention enable part of the gas from the membrane separator that would otherwise be sent to a flare to be recovered as product.

The first product gas stream may, for example, be liquefied or may be compressed and charged into pressure vessels such as gas cylinders.

The second product stream may be used as a feed to a fuel cell, particularly a molten carbonate fuel cell. For such use, it is desirable that the second product gas stream contains from 15% to 25% by volume of carbon dioxide, the balance being methane apart from residual impurities.

The method and apparatus according to the invention are particularly suited for the purification and separation of landfill gas. The feed stream may, however, be taken from a different source, for example, a biodigestion apparatus. If the feed gas stream is formed of landfill gas, it will typically contain a significant proportion of nitrogen impurity.

The source of the biologically generated gas is typically at atmospheric pressure. The feed gas may be withdrawn from the source by means of a blower and subjected to a preliminary purification upstream of compression. The preliminary purification preferably comprises the removal of hydrogen sulphide. The hydrogen sulphide may be removed by reaction with a suitable particulate scavenger of hydrogen sulphide, for example, a scavenger based on iron oxide.

The compressed biologically generated feed gas stream is preferably produced at a pressure in the range of 9 to 16 bar. The resultant compressed feed gas stream is preferably chilled so as to condense higher hydrocarbons therefrom, the condensate being collected in a suitable vessel.

The compressed feed stream is preferably purified by pressure swing adsorption or temperature swing adsorption. The adsorbent is preferably selected so as to adsorb water vapour and non-methane organic compounds in preference to or more rapidly than methane and carbon dioxide. Suitable adsorbents include activated alumina and silica gel.

The purified gas stream is preferably subjected to further purification by contact with a sacrificial adsorbent. The purified gas stream is preferably chilled upstream of the further purification, preferably to a temperature of minus 15° C. to minus 25° C. Some residual non-methane organic compounds condense at such temperatures. The resultant condensate is preferably collected.

The sacrificial adsorbent preferably comprises activated carbon. If desired, the sacrificial adsorbent also comprises 13X zeolite. The activated carbon and the 13X zeolite adsorbents can be deployed in an upstream bed of the former and a downstream bed of the latter. Alternatively, they can be deployed in a single bed with the activated carbon upstream of the 13X zeolite.

The separation of the purified gas stream by membranes is preferably performed in a plurality of stages in series. Typically, any membrane which has selectivity between carbon dioxide and methane may be used. A permeate gas typically enriched in carbon dioxide is produced in the first or upstream stage. The first stage permeate gas is preferably flared, but upstream of being flared may be used as an adsorbent purge gas.

The second or downstream stage permeate gas is preferably the gas which forms the intermediate gas stream enriched in carbon dioxide.

Landfill gas typically contains a significant proportion of nitrogen which is not removed either during the purification or the membrane separation. If the first product gas stream does contain a significant proportion of nitrogen, it may be subjected to further separation as between methane and nitrogen. The further separation is preferably performed by adsorption, more preferably vacuum swing adsorption. A molecular gate vacuum swing adsorption separation is particularly suitable. The further separation by adsorption typically produces a vent gas stream which may be sent to a flare. Alternatively, the vent gas stream from the further separation may be used at least in part to form the second product gas stream.

The second product gas stream typically comprises 75% to 85% by volume of methane and incidental impurities, and 15% to 25% by volume of carbon dioxide.

The method and apparatus according to the invention will now be described by way of example with reference to the accompanying drawing which is a flow diagram of a plant for treating landfill gas.

Referring to the drawing, a blower 2 withdraws landfill gas from a site at which it is produced. Landfill gas is a product of a series of complex chemical reactions involved in the decomposition of organic matter. The reactions produce, amongst other gases and compounds methane and carbon dioxide in roughly equal proportions. In addition, landfill gas typically contains water vapour, nitrogen, oxygen, siloxanes, hydrogen sulphide and a large number of NMOCs (non-methane organic compounds). The NMOCs may include benzene, chlorobenzene, ortho-xylene, para-dichlorobenzene, styrene, toluene, ethyltoluene, trimethyl benzene and various fluorocarbons. The proportions of all these constituents tend to vary according to the landfill site. They will also vary in any particular landfill site from day to day because the composition of the waste fed to the landfill will rarely be constant.

The plant illustrated in the drawing comprises several initial stages for purifying the landfill gas so as to form a mixture which consists essentially of methane, carbon dioxide, nitrogen and water vapour. The biologically generated landfill gas flows from the blower 2 through an aftercooler 4, in which it is cooled to approximately ambient temperature by, for example, heat exchange with a flow of water. The cooling of the landfill gas in the aftercooler 4 may cause some less volatile NMOCs to condense. Resulting condensate is collected in a phase separator 6. The resulting condensate may be periodically discharged from the process. The flow of compressed landfill gas passes from the phase separator 6 to a stage 8 for removing hydrogen sulphide impurity from the landfill gas. Typically, hydrogen sulphide may be present in an amount from 100 to 200 parts per million by volume in the landfill gas. The stage 8 may comprise any known unit for removing such levels of hydrogen sulphide from a gas stream. One commercially available unit is known by the name “Sulfatreat” and employs beds 10 and 12 of a suitable sacrificial adsorbent of hydrogen sulphide. The beds 10 and 12 are employed in a lead-lag configuration. The adsorbent is typically based on iron oxide and is effective to convert the hydrogen sulphide to iron sulphide. Typically, the hydrogen sulphide removal stage 8 is effective to reduce the impurity level of hydrogen sulphide to under 5 parts per million by volume.

A resultant gas stream, now essentially free of hydrogen sulphide, is compressed in a compressor 14 to a pressure in the order of 14 bar. In order to reach such a pressure, the compressor 14 preferably comprises two stages 16 and 18 with an intercooler 20 therebetween. The intercooler 20 is typically effective to remove heat of compression from the resultant gas stream by conducting heat exchange between the gas stream and a heat exchange fluid, typically water at ambient temperature. As a result of the heat exchange, water and some of the less volatile of the vaporous NMOCs are condensed. The resultant gas stream, now laden with droplets of condensate, passes to a phase separator 22 in which the condensate is disengaged from the gas. Phase separator 22 has at its bottom an outlet 24 for periodic discharge of the condensate. The gas stream from which the condensate has been disengaged passes to the second stage 18 of the compressor 14. From the second compression stage 18 the landfill gas flows through an arrangement of an aftercooler 26 and a further phase separator 28, which arrangement is wholly analogous to the arrangement of the intercooler 20 and the phase separator 22. As a result, further NMOCs are condensed and are disengaged from the landfill gas in the phase separator 28.

The landfill gas flows from the phase separator 28 to a first chiller 30 in which it is cooled to a temperature below ambient temperature by heat exchange with a suitable circulating refrigerant. Typically the landfill gas is cooled in the chiller 30 to a temperature in the order of 3° C. At such temperature, further water vapour and NMOCs are condensed. The landfill gas now laden again with droplets of condensate passes to a yet further phase separator 34 for disengagement of the compressed landfill gas from the condensate. The condensate may periodically be discharged through an outlet 36 at the bottom of the phase separator 34. The chilling of the compressed landfill gas reduces the adsorption load on a drier 40 downstream of the phase separator 36. The drier 40 is effective to remove essentially all of the residual water vapour, yet more of the NMOCs and other impurities such as siloxanes. The drier 40 may be provided by any conventional drier operating on a PSA (pressure swing adsorption) cycle. In this cycle, impurities are adsorbed from the landfill gas at essentially its inlet pressure to the drier 40 and are desorbed therefrom at essentially atmospheric pressure. Typically, just two adsorption vessels 42 and 44 in parallel are employed, but other arrangements are possible. Any conventional adsorbent of water vapour may be employed in the PSA drier 40. Examples are activated alumina and silica gel. The PSA drier 40 has an outlet 46 for a vent stream which typically contains some methane as well as the adsorbed impurities. The vent stream from the PSA drier 40 is typically sent to a flare and burnt.

Even though the various stages of condensation and PSA drying will remove a lot of the NMOCs from the landfill gas, there will still normally remain up to, say, 1000 ppm NMOCs in the resulting landfill gas, particularly the more volatile of these impurities. The partially purified, compressed landfill gas flows to a further chiller 48 in which it is cooled to a sub-zero temperature, for example, minus 20° C., by direct heat exchange with a circulating refrigerant. Such chilling is effective to condense a substantial proportion of the remaining NMOCs from the landfill gas. The resultant gas stream, laden with droplets of condensate, passes to a phase separator 50 in which the landfill gas is disengaged from the condensate. The condensate may be periodically discharged through a bottom outlet 52.

The landfill gas flows from the phase separator 50 to two further stages 54 and 56 of the adsorptive purification. In the upstream of these stages, the landfill gas passes through a sacrificial bed of activated carbon. The activated carbon is generally effective to remove all NMOCs except unsubstituted C2 to C4 hydrocarbons and certain halocarbons, particularly fluorocarbons. Such residual halocarbon impurities are removed in the downstream stage 56 in which the landfill gas passes through a bed of 13X zeolite. The removal of the halogenated NMOC compounds is particularly important as such compounds tend to have a particularly adverse effect on the polymeric membranes that are used downstream to separate the landfill gas into methane rich and carbon dioxide rich gas streams. The sacrificial adsorbents are typically replaced from time to time before they are fully loaded with impurities.

Various additions and modifications may be made to the purification process. For example, filters and other devices may be used to disengage particulate material from the landfill gas upstream of the blower 2. In addition, coalescing filters may be employed at various locations along the purification train. The PSA drier 40 may be replaced by a drier operating on a temperature swing adsorption cycle. The purification stages 54 and 56 may be operated with a means (not shown) for regenerating the adsorbent so that it does not need to be sacrificed. For example, a stream of steam or hot gas may be used for this purpose.

The stream of purified compressed landfill gas passed from the purification stage 56 to a membrane separator 58. The membrane separator 58 comprises an upstream stage 60 and a downstream stage 62. Both the stages 60 and 62 employ polymeric membranes that are able to effect separation between methane and carbon dioxide. The membranes may be unsupported or may each comprise a porous and non-selective support layer in addition to a layer of polymer that is able selectively to separate methane from carbon dioxide by virtue of their different rates of permeation therethrough. Such membranes are well known in the art. The membranes that are employed in the separation units 60 and 62 can be stacked in plate-and-frame modules or can be wound in spiral-wound modules. The rate of permeation of methane through the membranes is less than that of carbon dioxide.

Accordingly, the permeate gas is enriched in carbon dioxide and the retentate gas is enriched in methane. The permeate gas from the upstream stage 60 is preferably sent to a flare and burnt. If desired, upstream of the flare, it may be employed to purge desorbed impurities from the PSA drier 40. The retentate gas from the upstream membrane separation stage 60 flows to the downstream membrane separation stage 62 in which further separation of methane from carbon dioxide takes place. A retentate gas stream, now considerably enriched in methane and typically containing more than 70% by volume of methane is produced as a first product gas. A permeate gas stream, typically containing more than 60% by volume of carbon dioxide, but typically also containing more than 20% by volume of methane, is also produced as an intermediate gas stream.

The first product gas stream typically contains an appreciable proportion of nitrogen, for example, between 15% and 20% by volume.

The product gas stream is therefore sent to a further separation stage in order to effect a separation as between methane and nitrogen. The product gas stream is sent to a VSA (Vacuum Swing Adsorption) unit 70 to effect this separation. An adsorbent is employed in the VSA unit 70 that preferentially or more rapidly adsorbs nitrogen relative to methane. The VSA unit 70 is preferably of the molecular gate kind. Such VSA units are well known in the art and are commercially available from Englehard Corporation (now part of BASF Catalysts LLC). The VSA unit 70 includes a vacuum pump 72 which is used to withdraw desorbed gas from the unit 70. The desorbed gas typically contains at least 50% by volume of nitrogen, but also an appreciable volume of methane, and may be sent to a flare and burnt. Alternatively, it may be used in the purging of the beds of the PSA drier 40. The VSA unit 70 also produces a purified first product gas stream which flows out of the unit 70 to a first product gas pipeline 74. The purified first product gas stream typically contains more than 95% by volume of methane. The first pipeline 74 terminates in a liquefier 76 which is operated to liquefy the first product gas. The resulting liquefied natural gas is sent to a storage vessel 78.

Not all of the first product gas stream is sent to the liquefier 76. Some of it is used to form a second product gas stream. In order to form this second product gas, the intermediate (permeate) gas stream from the second unit 62 of the membrane separator 58 flows to a second pipeline 80 in which a compressor 82 is disposed. The compressor 82 is operated to raise the pressure of the intermediate gas stream to that of the first product gas stream. The resulting compressed intermediate gas stream flows from the compressor 82 into a third pipeline 84 which also communicates with the pipeline 70. A proportion of the first product gas is taken from the pipeline 70 upstream of the liquefier 76 and is mixed in the pipeline 84 with the intermediate gas stream to form a second product gas stream. The mixing is controlled so as to produce a second product gas stream which contains from 15% to 25% by volume of carbon dioxide. The second product gas stream is sent to a fuel cell 86 of the molten carbonate kind for the generation of electrical power. If desired, a part or all of the electrical power so generated may be used to drive machinery in the plant shown in the drawing. Alternatively, a part or all of the electrical power may be exported.

By employing the intermediate gas stream to form the second product gas stream, wastage of the methane content of the intermediate gas stream is avoided.

In a typical example of the method and apparatus according to the invention, the feed gas stream taken by the blower 2 may flow at a rate of 2293 scfm (standard cubic feet per minute). This feed gas stream typically comprises 46% by volume of methane, 12% by volume of nitrogen, 1% by volume of oxygen, and 40% by volume of carbon dioxide, balance impurities, on a dry basis. The flow to the inlet of the membrane separator 58 is 2504 scfm. The inflowing gas stream comprises 44% by volume of methane, 42% by volume of carbon dioxide and 12.5% by volume of nitrogen. 9016 scfm of permeate gas, containing 12% by volume of methane, is produced by the upstream membrane separation unit 60. The second membrane separation unit 62 produces 386 scfm of a gas mixture comprising 61% by volume of carbon dioxide, 26% by volume of methane, 11.6% by volume of nitrogen and 1.9% by volume of oxygen as the intermediate gas stream. It also produces 1197 scfm of an unpurified first product gas stream comprising 74.9% by volume of methane, 17.9% by volume of nitrogen and 6.7% by volume of carbon dioxide. The molecular gate VSA unit 80 produces a purified first product gas stream at a rate of 840 scfm. The purified product gas stream contains 96% by volume of methane.

1. A method of separating a compressed, biologically generated, feed gas stream comprising methane, carbon dioxide, water vapour and impurities including volatile non-methane organic compounds, comprising:
purifying the compressed, biologically generated, feed stream by adsorption to remove the volatile non-methane organic compounds and the water vapour and to form a purified feed stream;
separating the purified feed stream by membranes to produce a first product gas stream enriched in methane and an intermediate gas stream enriched in carbon dioxide; and
withdrawing a part of the first product gas stream therefrom and mixing said part with at least part of the intermediate gas stream to form a second product gas steam comprising methane and carbon dioxide.

2. A method according to claim 1, wherein the second product gas stream contains 15% to 25% by volume of carbon dioxide.

3. A method according to claim 1, wherein the second product gas stream is fed to a fuel cell.

4. A method according to claim 3, wherein the fuel cell is of a molten carbonate kind.

5. A method according to claim 1, wherein the biologically generated gas is landfill gas.

6. A method according to claim 5, wherein the landfill gas is subjected to a preliminary purification comprising the removal of hydrogen sulphide upstream of its compression.

7. A method according to claim 1, wherein the compressed, biologically generated, feed gas stream is produced at a pressure in the range of 9 to 16 bar.

8. A method according to claim 7, in which the compressed, biologically generated, feed gas stream is chilled upstream if its purification.

9. A method according to claim 1, wherein the com[pressed, biologically generated, feed gas stream is purified by pressure swing adsorption or temperature swing adsorption.

10. A method according to claim 9, wherein the purified gas stream is subjected to further purification by contact with a sacrificial adsorbent.

11. A method according to claim 10, wherein the purified gas stream is chilled upstream of the further purification.

12. A method according to claim 11, wherein the purified gas stream is chilled to a temperature in the range of minus 15° C. to minus 25° C.

13. A method according to claim 10, wherein the sacrificial adsorbent comprises actuated carbon.

14. A method according to claim 13, wherein the sacrificial adsorbent additionally comprises 13X zeolite.

15. A method according to claim 1, wherein the separation of the purified gas mixture by membranes is performed in a plurality of stages in series.

16. A method according to claim 15, wherein there are two stages of membrane separation in series, the permeate gas from the downstream stage forming the intermediate gas stream and the retentive gas from the downstream stage forming the first product gas stream.

17. A method according to claim 1, wherein the first product gas stream is subjected to further separation as between methane and nitrogen.

18. A method according to claim 17, wherein the further separation is performed by vacuum swing adsorption.

19. A method according to claim 18, wherein the vacuum swing adsorption is a molecular gate vacuum swing adsorption.

20. A method according to claim 1, wherein the second product gas stream comprises from 15% to 25% by volume of carbon dioxide, the balance being methane and incidental impurities.

21. Apparatus for separating a compressed, biologically generated, feed gas stream comprising methane, carbon dioxide, water vapour and impurities including volatile non-methane organic compounds, comprising
at least one adsorber for removing the volatile non-methane organic compounds and the water vapour and for forming a purified feed stream;
at least one membrane separator for producing from the purified feed stream a first product gas stream enriched in methane and an intermediate gas stream enriched in carbon dioxide;
a first pipeline for conducting part of the product gas stream to a first outlet from the apparatus;
a second pipeline for conducting the intermediate gas stream from the said membrane separator;
a third pipeline for conducting a second product gas stream from the apparatus;
wherein the third pipeline communicates with both the first pipeline and the second pipeline so as to enable a mixture of part of the first product gas stream and at least part of the intermediate gas stream to be formed as the second product gas stream.
